(19) United States
(12) Patent Application Publication
(10) Pub. No.: US 2026/0083110 A1
(43) Pub. Date: Mar. 26, 2026

(54) FISHING ROD HOOK SAFETY SYSTEM

(71) Applicant: Ricky Dale Collins, Wadesboro, NC (US)

(72) Inventor: Ricky Dale Collins, Wadesboro, NC (US)

(21) Appl. No.: 18/894,364

(22) Filed: Sep. 24, 2024

(51) Int. Cl. A01K 87/00

(52) U.S. Cl. CPC A01K 87/009

(57) ABSTRACT

A fishing pole is taught having fishing line with an attached single barb fishing hook which also comprises a slot for inserting the barb for safety.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to fishing equipment. More particularly it relates to a fish hook safety device.

### Description of Related Art

Fishing hooks by virtue of their design in having a sharp pointed and barbed end can be extremely dangerous. While there are fishing hooks with multiple barbed ends the vast majority of fishing hooks are a single barb, J shaped design. The major problem with fishing hooks is their tendency to snag or attach to anything around it, including the fisherman or his clothes which can easily result in an injury. This is more likely when the hook is attached to a fishing line on a fishing pole.

While several safety devices have been used to help prevent injury. They all are bulky and difficult to add to a fishing pole without getting in the way of the use of the fishing pole. Some devices only give partial protection.

### BRIEF SUMMARY OF THE INVENTION

The present invention relates to a fishing pole with a slot in the handle for positioning a fish hook to prevent injury.

Accordingly, in one embodiment, there is a fishing pole having a fishing line end strung though eyelets from a rod tip to a base comprising:
a) a single barb fish hook positioned on the fishing line end; and
b) a slot in the base positioned to receive the fishing hook barb.

### BRIEF DESCRIPTION OF THE DRAWINGS

FIG. 1 is a perspective view of a fishing pole having a hook safety system.

FIG. 2 is a portion of a fishing pole showing the fish hook positioned in a slot built into the base.

FIG. 3 is an alternate version of slot a slot wherein the slot is an add on to the pole.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The Terms “about” and “essentially” Mean ±10 Percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “fishing pole” refers to a long pole made of wood, plastic, and the like with a fishing line attached to it, strung through eyelets and a hook at the end of the line, used for catching fish. In the present invention the hook is a single barb fish hook.

As used herein, the term “fishing line end” refers to the end of the fishing line which attaches to the fish hook.

As used herein, the term “strung through eyelets” refers to the fishing line passing through several eyelets from the pole tip end to the pole handle.

As used herein, the term “single barb fish hook” refers to a curved piece of metal with a single barb (i.e. a sharp point that curves backward) at one end, used for catching fish.

As used herein, the term “slot” refers to a long narrow hole designed to accommodate the barbed end of the fish hook such that it cannot catch on some object or person. This is especially useful when transporting the fishing pole. The slot can be positioned in the fishing pole at or near the handle, or a device can be attached to an existing fishing pole with no slot. The slot runs parallel to the fishing pole.

As used herein, the term “attachment to the base” refers to when a device is attached to the fishing pole which has the slot it is position at or near the handle of the fishing pole.

### Drawings

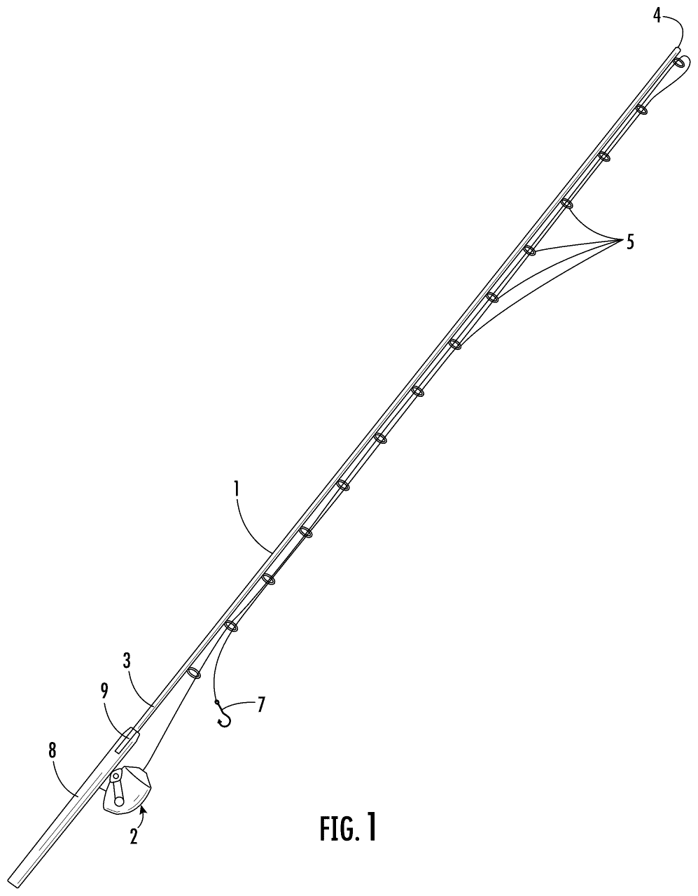

Now referring to the drawings, FIG. 1 is a perspective view of a fishing pole having a hook safety system. Fishing pole 1 has fishing reel 2 with fishing line 3. The fishing line 3 runs up to the rod tip 4 and then back down through a series of eyelets 5. At the end of the fishing line is a single barb fish hook 7. The base or handle 8 has a slot 9 positioned parallel with the fishing pole to receive the fish hook barb.

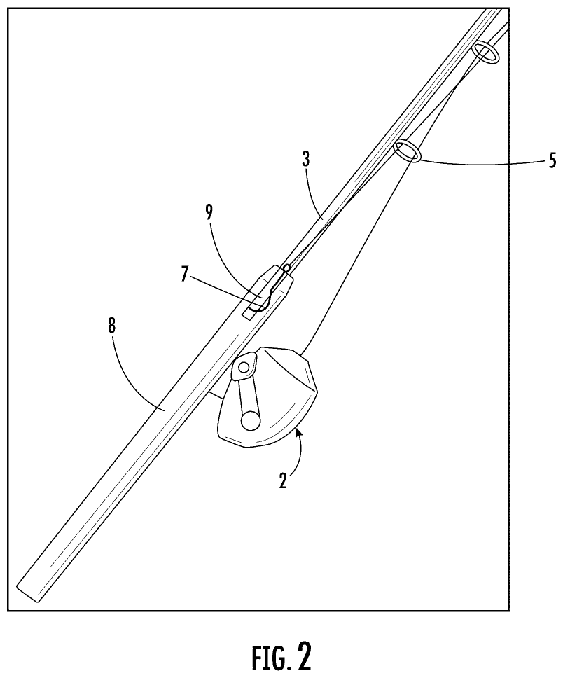

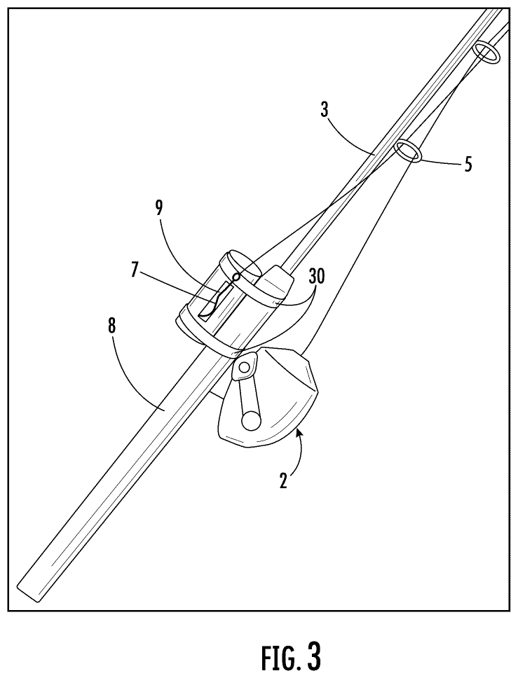

FIG. 2 is a portion of fishing pole 1 showing the fish hook 7 positioned in slot 9 built into the base. FIG. 3 is an alternate version of slot 9 wherein the slot is an add on to the pole. In this version there are straps 30 to hold the slot 9 in place on base 8.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A fishing pole having a fishing line end strung though eyelets from a rod tip to a base consisting of:
a) a single barb fish hook positioned on the fishing line end; and
b) a slot which runs parallel to the fishing pole and has parallel sides cut in the handle positioned to receive the fishing hook barb.

2. (canceled)

3. (canceled)

4. A fishing pole having a fishing line end strung though eyelets from a rod tip to a base consisting of:
a) a single barb fish hook positioned on the fishing line end; and
b) a device attached to the handle having a slot which runs parallel to the fishing pole and has parallel sides positioned to receive the fishing hook barb.

5. The fishing pole according to claim 4 wherein the slot is positioned on the side of the device.
